(19) United States
(12) Patent Application Publication
(10) Pub. No.: US 2024/0430135 A1
(43) Pub. Date: Dec. 26, 2024

(54) INTERFERENCE REDUCTION

(71) Applicant: QUALCOMM Incorporated, San Diego, CA (US)

(72) Inventors: Igor GUTMAN, Hod HaSharon (IL); Jing JIANG, San Diego, CA (US); Tao LUO, San Diego, CA (US)

(21) Appl. No.: 18/339,568

(22) Filed: Jun. 22, 2023

(51) Int. Cl. H04L 25/02; H04B 1/525; H04B 7/0456; H04L 5/14

(52) U.S. Cl. CPC H04L 25/0242; H04B 1/525; H04B 7/0456; H04L 5/14

(57) ABSTRACT

Various aspects of the present disclosure generally relate to wireless communication. In some aspects, a transmitter device may obtain a first channel matrix associated with communications between a transmitter device transmission antenna and a transmitter device reception antenna and a second channel matrix associated with communications between the transmitter device transmission antenna and a receiver device reception antenna associated with a receiver device. The transmitter device may generate a combined channel matrix based at least in part on the first channel matrix and the second channel matrix. The transmitter device may reduce interference between the transmitter device transmission antenna and the transmitter device reception antenna based at least in part on multiplying the combined channel matrix by a precoding matrix. Numerous other aspects are described.

### FIELD OF THE DISCLOSURE

Aspects of the present disclosure generally relate to wireless communication and to techniques and apparatuses for interference reduction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitter device. The method may include obtaining a first channel matrix associated with communications between a transmitter device transmission antenna and a transmitter device reception antenna and a second channel matrix associated with communications between the transmitter device transmission antenna and a receiver device reception antenna associated with a receiver device. The method may include generating a combined channel matrix based at least in part on the first channel matrix and the second channel matrix. The method may include reducing interference between the transmitter device transmission antenna and the transmitter device reception antenna based at least in part on multiplying the combined channel matrix by a precoding matrix.

Some aspects described herein relate to a method of wireless communication performed by a transmitter device. The method may include obtaining a first channel matrix associated with communications between a transmitter device transmission antenna and a transmitter device reception antenna and a second channel matrix associated with communications between the transmitter device transmission antenna and a receiver device reception antenna associated with a receiver device. The method may include generating a combined channel matrix based at least in part on the first channel matrix and the second channel matrix. The method may include reducing an undesired distortion between the transmitter device transmission antenna and the transmitter device reception antenna based at least in part on a product of a distortion transition matrix and a symbol-domain transform of the undesired distortion.

Some aspects described herein relate to a transmitter device for wireless communication. The transmitter device may include one or more memories and one or more processors coupled to the one or more memories. The one or more processors may be configured to obtain a first channel matrix associated with communications between a transmitter device transmission antenna and a transmitter device reception antenna and a second channel matrix associated with communications between the transmitter device transmission antenna and a receiver device reception antenna associated with a receiver device. The one or more processors may be configured to generate a combined channel matrix based at least in part on the first channel matrix and the second channel matrix. The one or more processors may be configured to reduce interference between the transmitter device transmission antenna and the transmitter device reception antenna based at least in part on multiplying the combined channel matrix by a precoding matrix.

Some aspects described herein relate to a transmitter device for wireless communication. The transmitter device may include one or more memories and one or more processors coupled to the one or more memories. The one or more processors may be configured to obtain a first channel matrix associated with communications between a transmitter device transmission antenna and a transmitter device reception antenna and a second channel matrix associated with communications between the transmitter device transmission antenna and a receiver device reception antenna associated with a receiver device. The one or more processors may be configured to generate a combined channel matrix based at least in part on the first channel matrix and the second channel matrix. The one or more processors may be configured to reduce an undesired distortion between the transmitter device transmission antenna and the transmitter device reception antenna based at least in part on a product of a distortion transition matrix and a symbol-domain transform of the undesired distortion.

Some aspects described herein relate to a non-transitory computer-readable medium that stores a set of instructions for wireless communication by a transmitter device. The set of instructions, when executed by one or more processors of the transmitter device, may cause the transmitter device to obtain a first channel matrix associated with communications between a transmitter device transmission antenna and a transmitter device reception antenna and a second channel matrix associated with communications between the transmitter device transmission antenna and a receiver device reception antenna associated with a receiver device. The set of instructions, when executed by one or more processors of the transmitter device, may cause the transmitter device to generate a combined channel matrix based at least in part on the first channel matrix and the second channel matrix. The set of instructions, when executed by one or more processors of the transmitter device, may cause the transmitter device to reduce interference between the transmitter device transmission antenna and the transmitter device reception antenna based at least in part on multiplying the combined channel matrix by a precoding matrix.

Some aspects described herein relate to a non-transitory computer-readable medium that stores a set of instructions for wireless communication by a transmitter device. The set of instructions, when executed by one or more processors of the transmitter device, may cause the transmitter device to obtain a first channel matrix associated with communications between a transmitter device transmission antenna and a transmitter device reception antenna and a second channel matrix associated with communications between the transmitter device transmission antenna and a receiver device reception antenna associated with a receiver device. The set of instructions, when executed by one or more processors of the transmitter device, may cause the transmitter device to generate a combined channel matrix based at least in part on the first channel matrix and the second channel matrix. The set of instructions, when executed by one or more processors of the transmitter device, may cause the transmitter device to reduce an undesired distortion between the transmitter device transmission antenna and the transmitter device reception antenna based at least in part on a product of a distortion transition matrix and a symbol-domain transform of the undesired distortion.

Some aspects described herein relate to an apparatus for wireless communication. The apparatus may include means for obtaining a first channel matrix associated with communications between a transmitter device transmission antenna and a transmitter device reception antenna and a second channel matrix associated with communications between the transmitter device transmission antenna and a receiver device reception antenna associated with a receiver device. The apparatus may include means for generating a combined channel matrix based at least in part on the first channel matrix and the second channel matrix. The apparatus may include means for reducing interference between the transmitter device transmission antenna and the transmitter device reception antenna based at least in part on multiplying the combined channel matrix by a precoding matrix.

Some aspects described herein relate to an apparatus for wireless communication. The apparatus may include means for obtaining a first channel matrix associated with communications between a transmitter device transmission antenna and a transmitter device reception antenna and a second channel matrix associated with communications between the transmitter device transmission antenna and a receiver device reception antenna associated with a receiver device. The apparatus may include means for generating a combined channel matrix based at least in part on the first channel matrix and the second channel matrix. The apparatus may include means for reducing an undesired distortion between the transmitter device transmission antenna and the transmitter device reception antenna based at least in part on a product of a distortion transition matrix and a symbol-domain transform of the undesired distortion.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of interference in a wireless network, in accordance with the present disclosure.

FIG. 5 is a diagram illustrating an example of interference reduction, in accordance with the present disclosure.

FIG. 6 is a diagram illustrating an example process performed, for example, by a transmitter device, in accordance with the present disclosure.

FIG. 7 is a diagram illustrating an example process performed, for example, by a transmitter device, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A full-duplex (FD) communication system may enable simultaneous data transmission and reception. For example, a network node using FD communications may transmit data to a user equipment (UE) and receive data from the UE at the same time and on the same frequency resource. A communication (e.g., an FD communication) may be transmitted by a device using a transmission (Tx) path and via a power amplifier (PA) of the device. Another FD communication, such a signal transmitted by another device, may be received by the device using a receiver (Rx) path and via a low-noise amplifier (LNA) of the device. The FD communication transmitted using the Tx path may result in self-interference (SI) on the Rx path. The SI may be a result of leakage from the Tx path to the Rx path. Additionally, or alternatively, the SI may be a result of the signal being reflected off of a reflector onto the Rx path. In some cases, the signal transmitted via the Tx path may result in cross-interference (CI) to a victim device, such as a victim network node or a victim UE. In some cases, SI may be reduced using sub-band full-duplex (SBFD) communications in which some component carriers (CCs) are used for Tx and other CCs are used for Rx, resulting in orthogonal Tx and Rx communications. However, the impact of SI in SBFD communications may result in LNA saturation and/or may result in the Tx signal being spread in the frequency domain (e.g., due to the PA) and, therefore, the Tx and Rx communications may no longer be orthogonal. In some cases, non-linear interference cancelation (NLIC) may enable Tx SI that is leaked to the Rx to be modeled in the digital domain and to be canceled out. Additionally, or alternatively, analog cancelation may be applied by leaking a linear portion of the signal with a negative phase. However, interference may still occur, for example, at the LNA of the device. This may reduce end-to-end (E2E) performance.

Various aspects relate generally to wireless communication. Some aspects more particularly relate to interference reduction. In some examples, a transmitter device (such as a network node) may reduce linear interference at a receiver of the transmitter device. The transmitter device may obtain a first channel matrix associated with communications between a transmitter device Tx antenna and a transmitter device Rx antenna and may obtain a second channel matrix associated with communications between the transmitter device Tx antenna and a receiver device Rx antenna. The receiver device may be a UE or may be another network node. The transmitter device may generate a combined channel matrix based at least in part on combining the first channel matrix and the second channel matrix. The transmitter device may reduce interference between the transmitter device Tx antenna and the transmitter device Rx antenna based at least in part on multiplying the combined channel matrix by a precoding matrix. In some other examples, the transmitter device may reduce non-linear interference, such as undesired distortion at the receiver of the transmitter device. For example, the transmitter device may obtain the first channel matrix and the second channel matrix, may generate the combined channel matrix based at least in part on combining the first channel matrix and the second channel matrix, and may reduce an undesired distortion between the transmitter device Tx antenna and the transmitter device Rx antenna based at least in part on multiplying a transition matrix associated with the undesired distortion by a symbol-domain transform of the undesired distortion.

Particular aspects of the subject matter described in this disclosure can be implemented to realize one or more of the following potential advantages. In some examples, the described techniques can be used to reduce interference and undesired distortion at a transmitter device (e.g., network node) reception antenna. In particular, the described techniques can be used to reduce or eliminate linear and/or non-linear self-interference in full-duplex communication systems. This may allow for full-duplex communications without analog front-end and low-noise amplification saturation. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

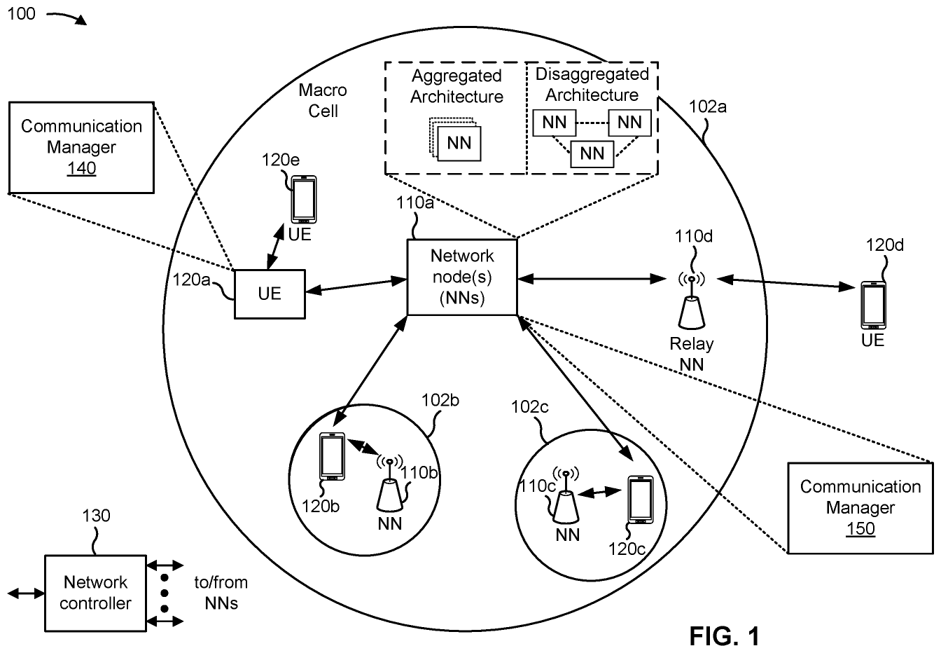

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHZ-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a. FR4-1, and/or FR5) may be modified, and techniques described herein are applicable to those modified frequency ranges.

In some aspects, the UE 120 may include a communication manager 140. As described in more detail elsewhere herein, in some aspects, the communication manager 140 may obtain a first channel matrix associated with communications between a transmitter device transmission antenna and a transmitter device reception antenna and a second channel matrix associated with communications between the transmitter device transmission antenna and a receiver device reception antenna associated with a receiver device; generate a combined channel matrix based at least in part on the first channel matrix and the second channel matrix; and reduce interference between the transmitter device transmission antenna and the transmitter device reception antenna based at least in part on multiplying the combined channel matrix by a precoding matrix. In some other aspects, the communication manager 140 may obtain a first channel matrix associated with communications between a transmitter device transmission antenna and a transmitter device reception antenna and a second channel matrix associated with communications between the transmitter device transmission antenna and a receiver device reception antenna associated with a receiver device; generate a combined channel matrix based at least in part on the first channel matrix and the second channel matrix; and reduce an undesired distortion between the transmitter device transmission antenna and the transmitter device reception antenna based at least in part on a product of a distortion transition matrix and a symbol-domain transform of the undesired distortion. Additionally, or alternatively, the communication manager 140 may perform one or more other operations described herein.

In some aspects, the network node 110 may include a communication manager 150. As described in more detail elsewhere herein, in some aspects, the communication manager 150 may obtain a first channel matrix associated with communications between a transmitter device transmission antenna and a transmitter device reception antenna and a second channel matrix associated with communications between the transmitter device transmission antenna and a receiver device reception antenna associated with a receiver device; generate a combined channel matrix based at least in part on the first channel matrix and the second channel matrix; and reduce interference between the transmitter device transmission antenna and the transmitter device reception antenna based at least in part on multiplying the combined channel matrix by a precoding matrix. In some other aspects, the communication manager 150 may obtain a first channel matrix associated with communications between a transmitter device transmission antenna and a transmitter device reception antenna and a second channel matrix associated with communications between the transmitter device transmission antenna and a receiver device reception antenna associated with a receiver device; generate a combined channel matrix based at least in part on the first channel matrix and the second channel matrix; and reduce an undesired distortion between the transmitter device transmission antenna and the transmitter device reception antenna based at least in part on a product of a distortion transition matrix and a symbol-domain transform of the undesired distortion. Additionally, or alternatively, the communication manager 150 may perform one or more other operations described herein.

As indicated above, FIG. 1 is provided as an example. Other examples may differ from what is described with regard to FIG. 1.

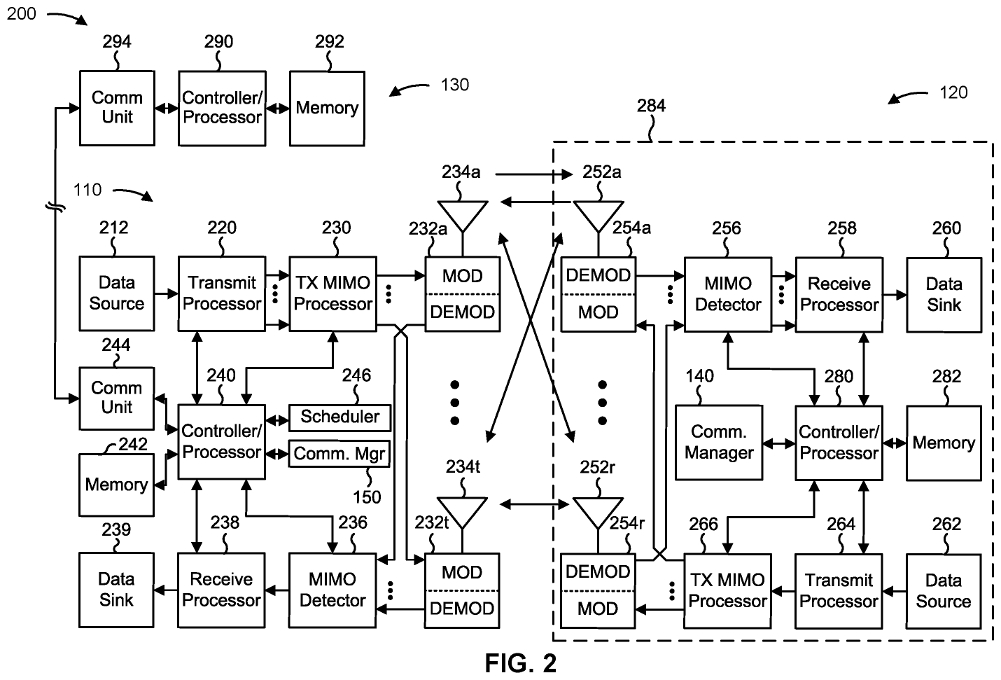

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

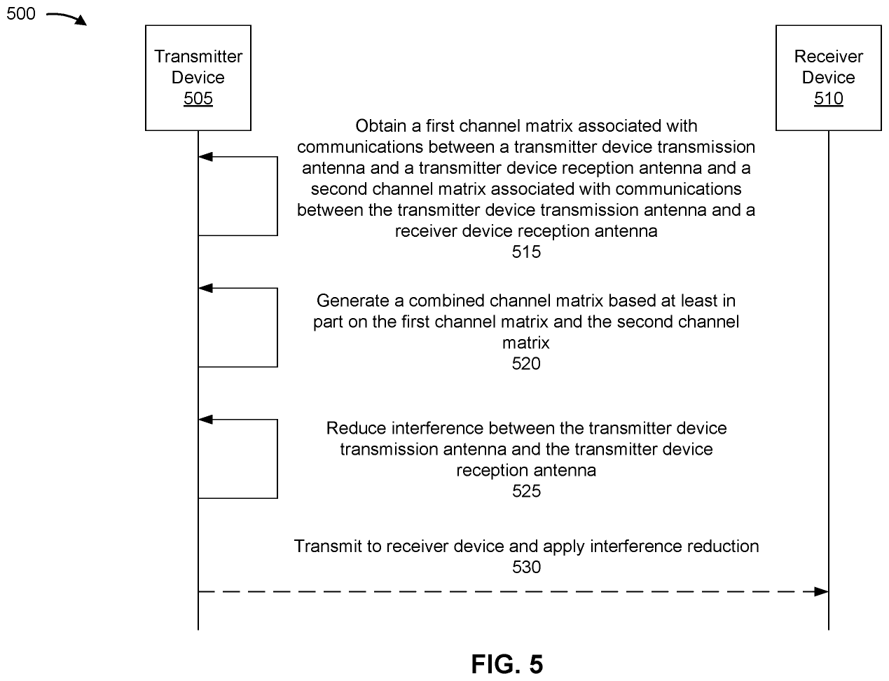

On the uplink, at the UE 120, a transmit processor 264 may receive and process data from a data source 262 and control information (e.g., for reports that include RSRP. RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

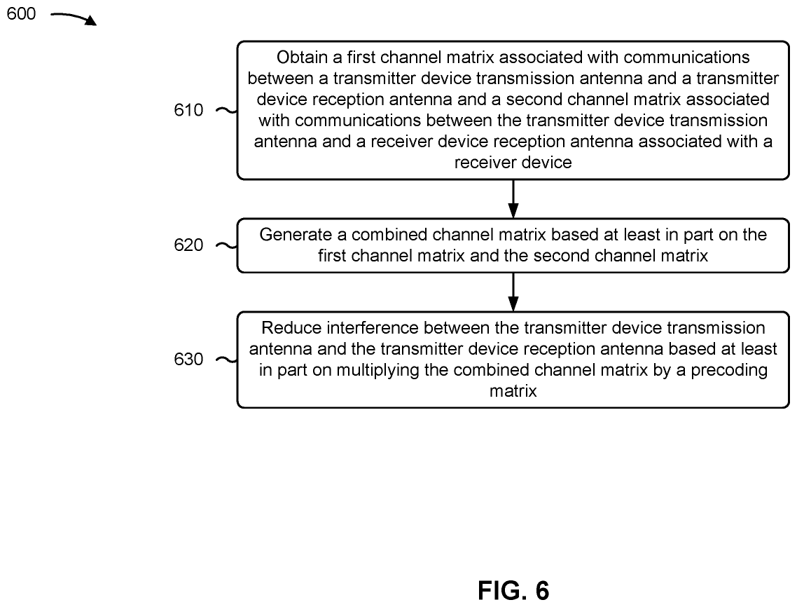

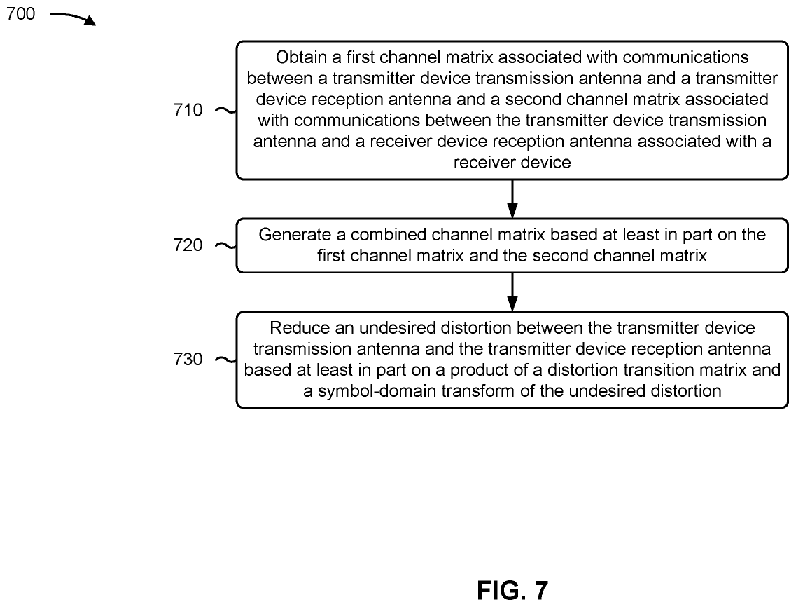

The controller/processor 240 of the network node 110, the controller/processor 280 of the UE 120, and/or any other component(s) of FIG. 2 may perform one or more techniques associated with interference reduction, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a transmitter device (e.g., the network node 110 or the UE 120) includes means for obtaining a first channel matrix associated with communications between a transmitter device transmission antenna and a transmitter device reception antenna and a second channel matrix associated with communications between the transmitter device transmission antenna and a receiver device reception antenna associated with a receiver device; means for generating a combined channel matrix based at least in part on the first channel matrix and the second channel matrix; and/or means for reducing interference between the transmitter device transmission antenna and the transmitter device reception antenna based at least in part on multiplying the combined channel matrix by a precoding matrix. In some aspects, the means for the transmitter device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitter device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a transmitter device (e.g., the network node 110 or the UE 120) includes means for obtaining a first channel matrix associated with communications between a transmitter device transmission antenna and a transmitter device reception antenna and a second channel matrix associated with communications between the transmitter device transmission antenna and a receiver device reception antenna associated with a receiver device; means for generating a combined channel matrix based at least in part on the first channel matrix and the second channel matrix; and/or means for reducing an undesired distortion between the transmitter device transmission antenna and the transmitter device reception antenna based at least in part on a product of a distortion transition matrix and a symbol-domain transform of the undesired distortion. In some aspects, the means for the transmitter device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitter device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

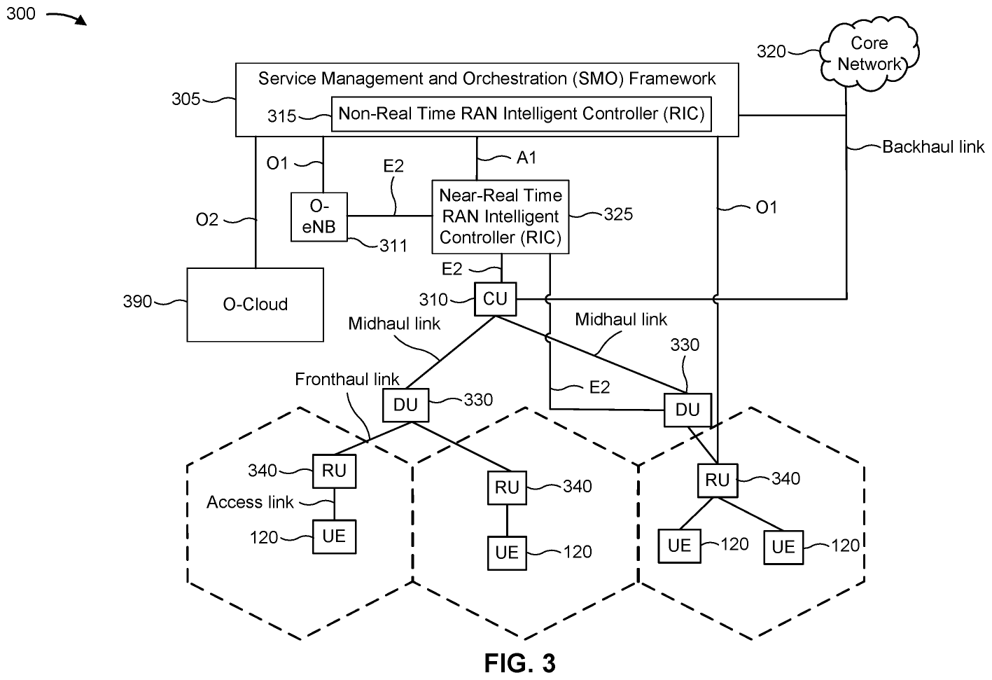

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

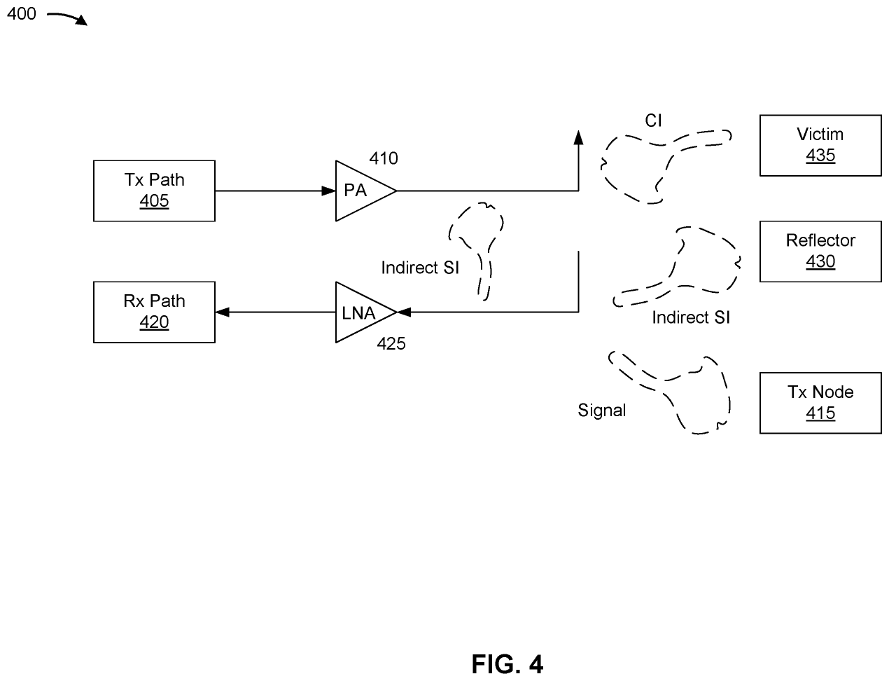

FIG. 4 is a diagram illustrating an example 400 of interference in a wireless network, in accordance with the present disclosure.

An FD communication system may enable simultaneous data transmission and reception. For example, a network node using FD communications may transmit data to a UE and receive data from the UE at the same time and on the same frequency resource. This is in contrast to half-duplex (HD) communication systems that allow only one device to transmit data on the frequency resource at the same time. FD communications may enable latency reduction. For example, a Tx device may be able to transmit a downlink communication to one node while receiving an uplink communication from another node at the same time. This may reduce potential uplink and downlink contention and, therefore, may result in reduced latency (particularly in asymmetric links). FD may allow for a reduction in routing latency. For example, a route selection algorithm may activate adjacent hops simultaneously while an intermediate node operates in both downlink and uplink directions, thereby reducing the routing delay. FD communications may enable an increase in throughput. To reduce throughput without FD, a high signal-to-noise ratio (SNR) may be needed. For an SNR that is greater than (e.g., significantly greater than) 10 decibels (dB), SNR\hat{ }m may be required to increase throughput by a factor of m. In FR2, an increase in SNR may be difficult to achieve since performance may be limited by non-thermal impairments (such as phase noise, PA non-linearity, and/or frequency domain residual side band (FDRSB) compensation), which may limit the SNR (e.g., by 30 dB). In one example, to increase throughput by a factor of two (e.g., 64 quadrature amplitude modulation (QAM) to 4096 QAM), the floors may need to be reduced by 20 dB, which may be impractical, for example, in millimeter wave (mmW) links.

As shown in the example 400, an FD communication may be transmitted by a device using a Tx path 405 and via a PA 410 of the device. Another FD communication, such a signal transmitted by a Tx node 415, may be received by the device using an Rx path 420 and via an LNA 425 of the device. The FD communication transmitted using the Tx path 405 may result in SI (e.g., indirect SI) on the Rx path 420. The SI may be a result of leakage from the Tx path 405 to the Rx path 420. Additionally, or alternatively, the SI may be a result of the signal being reflected off of a reflector 430 (e.g., an obstacle) onto the Rx path 420. In some cases, the signal transmitted via the Tx path 405 may result in CI to a victim 435, such as a victim network node or a victim UE.

In some cases, SI may be reduced using SBFD communications in which some component carriers are used for Tx and other CCs are used for Rx. This may reduce or eliminate leakage between Tx and Rx components. In one example, spectrum leakage due to PA non-linearity that results from the Tx leaking into adjacent Rx CCs may limit Rx performance. NLIC may be used to reduce this spectrum leakage. For example, an NLIC component in the Rx path 420 may model the received Tx signal and may digitally cancel the interference. SBFD may not directly increase throughput, but may allow for reduced latency (as in FD). In some cases, NLIC may enable Tx SI that is leaked to the Rx path 420 to be modeled in the digital domain and to be canceled out. Additionally, or alternatively, analog cancelation may be used to leak a linear portion of the signal (from Tx intermediate frequency (IF) to Rx IF) with a negative phase. Analog beamforming may be used to apply an analog Rx null on the signal, for example, using post-LNA phase shifters. However, interference may still occur, for example, due to an analog-front end (AFE) (such as LNA) non-linear response. Since the signal at the input to the Rx antenna may be larger than expected due to the SI, LNA saturation may noticeably affect E2E performance.

As indicated above, FIG. 4 is provided as an example. Other examples may differ from what is described with regard to FIG. 4.

FIG. 5 is a diagram illustrating an example 500 of interference reduction, in accordance with the present disclosure. A transmitter device 505 may communicate with a receiver device 510. In some aspects, the transmitter device 505 may be a network node and the receiver device 510 may be a UE (or multiple UEs) or another network node (or multiple network nodes). In some other aspects, the transmitter device 505 may be a UE and the receiver device 510 may be another UE (or multiple UEs) or a network node (or multiple network nodes). The transmitter device 505 may be configured to transmit communications to the receiver device 510 and to receive communications from the receiver device 510. Similarly, the receiver device 510 may be configured to transmit communications to the transmitter device 505 and to receive communications from the transmitter device 505.

As shown by reference number 515, the transmitter device 505 may obtain a first channel matrix associated with communications between a transmitter device transmission antenna and a transmitter device reception antenna. The transmitter device transmission antenna may be (or may include) one or more antennas included in the transmitter device 505 used for transmitting data to the receiver device 510. The transmitter device reception antenna may be (or may include) one or more antennas included in the transmitter device 505 for receiving data from the receiver device 510. The transmitter device 505 may obtain a second channel matrix associated with communications between the transmitter device transmission antenna and a receiver device reception antenna. The receiver device reception antenna may be (or may include) one or more antennas included in the receiver device 510 for receiving data from the transmitter device 505.

In some aspects, the transmitter device 505 may transmit to multiple receiver devices 510, and may leak SI to the transmitter device reception antenna. The transmitter device 505 may be equipped with N_{T} transmitter device transmission antennas and NRs transmitter device reception antennas. The multiple receiver devices 510 may be equipped with NR receiver device reception antennas. A sum of the number of receiver device reception antennas and the number of transmitter device reception antennas may be less than or equal to the number of transmitter device transmission antennas (N_{R}+N_{RS}≤N_{T}). Additionally, the number of receiver device reception antennas may be greater than or equal to the number of transmitter device reception antennas (N_{R}≥N_{RS}). As described above, the transmitter device 505 may obtain a first channel matrix (H_{N}_{_{RS}}_{×N}_{_{T}}^{self}) associated with communications between the transmitter device transmission antenna and the transmitter device reception antenna and may obtain a second channel matrix (H_{N}_{_{R}}_{×N}_{_{T}}^{target}) associated with communications between the transmitter device transmission antenna and the receiver device reception antenna.

As shown by reference number 520, the transmitter device 505 may generate a combined channel matrix (e.g., a general channel matrix). The transmitter device 505 may generate a combined channel matrix (H_{N}_{_{R}}_{+N}_{_{RS}}_{×N}_{_{T}}^{total}) based at least in part on the first channel matrix (H_{N}_{_{RS}}_{×N}_{_{T}}^{self}) and the second channel matrix (H_{N}_{_{R}}_{×N}_{_{T}}^{target}).

As shown by reference number 525, the transmitter device 505 may reduce or eliminate interference at the transmitter device reception antenna. For example, the transmitter device 505 may reduce or eliminate SI between the transmitter device transmission antenna and the transmitter device reception antenna.

In some aspects, reducing or eliminating the interference may include reducing or eliminating linear interference. In this case, an E2E equation may be represented by the following:

$${y}_{{N}_{R} + {N}_{RS} \times 1} = {H}_{{N}_{R} + {N}_{RS} \times {N}_{T}}^{total} \cdot {P}_{{N}_{T} \times {N}_{R} + {N}_{RS}} \cdot ( \begin{matrix}{S}_{{N}_{R} \times 1} \\ {0}_{{N}_{RS} \times 1}\end{matrix} ) + {n}_{{N}_{R} + {N}_{RS} \times 1} ,$$

where:
y_{N}_{_{R}}_{+N}_{_{RS}}_{×1} is a total received signal by the transmitter device reception antenna,
H_{N}_{_{R}}_{+N}_{_{RS}}_{×N}_{_{T}}^{total} is a combined channel matrix,
P_{N}_{_{T}}_{×N}_{_{R}}_{+N}_{_{RS}} is a precoding matrix,

$$( \begin{matrix}{S}_{{N}_{R} \times 1} \\ {0}_{{N}_{RS} \times 1}\end{matrix} )$$

is a null matrix, and
N_{N}_{_{R}}_{+N}_{_{RS}}_{×1} is channel noise.

To reduce the SI leakage at each of the transmitter device reception antennas at the transmitter device 505, the following equation may be used:

$${H}_{{N}_{R} + {N}_{RS} \times {N}_{T}}^{total} \cdot {P}_{{N}_{T} \times {N}_{R} + {N}_{RS}} = I ( {N}_{R} + {N}_{RS} ) \to {P}_{{N}_{T} \times {N}_{R} + {N}_{RS}} = {{H}_{{N}_{R} + {N}_{RS} \times {N}_{T}}^{total}}^{H} \cdot {( {H}_{{N}_{R} + {N}_{RS} \times {N}_{T}}^{total} \cdot {{H}_{{N}_{R} + {N}_{RS} \times {N}_{T}}^{total}}^{H} )}^{- 1} ,$$

where:
I(N_{R}+N_{RS}) is an eye matrix having a size that is based at least in part on N_{R}+N_{RS},
H_{N}_{_{R}}_{+N}_{_{RS}}_{×N}_{_{T}}^{total H} is a Hermitian combined channel matrix, and
(H_{N}_{_{R}}_{+N}_{_{RS}}_{×N}_{_{T}}^{total}·H_{N}_{_{R}}_{+N}_{_{RS}}_{×N}_{_{T}}^{total H})⁻¹ is an inverse of a product of the combined channel matrix and the Hermitian combined channel matrix.

The above examples are zero-forcing (ZF) optimal in clean conditions (e.g., without thermal inputs). In the case of thermal inputs, diagonal loading may be added as a minimum mean square error (MMSE) extension. In an example in which the target precoding matrix is dictated by other criteria, the target precoding matrix may be found by estimating H_{N}_{_{R}}_{×N}_{_{T}}^{targetEst}=(P_{N}_{_{T}}_{×N}_{_{R}})⁺ (where (P_{N}_{_{T}}_{×N}_{_{R}})⁺ is a conjugate transpose of the precoding matrix having a size that is based at least in part on N_{R}+N_{RS}), and then using H_{N}_{_{R}}_{×N}_{_{T}}^{targetEst} instead of H_{N}_{_{R}}_{×N}_{_{T}}^{target} (as described in more detail below).

In some aspects, reducing or eliminating the interference may include reducing or eliminating an undesired distortion associated with non-linear interference. In this example, the transmitter device 505 may be equipped with one or more power amplifiers. For example, the transmitter device 505 may be equipped with one power amplifier for each transmitter device transmission antenna of the transmitter device 505. In the example of undesired distortion associated with non-linear interference, the E2E equation may be represented as follows:

$${y}_{{N}_{R} + {N}_{RS} \times 1} = {H}_{{N}_{R} + {N}_{RS} \times {N}_{T}}^{total} \cdot F ( {P}_{{N}_{T} \times {N}_{R}} \cdot {s}_{{N}_{R} \times 1} ) + {n}_{{N}_{R} + {N}_{RS} \times 1} ,$$

s_{N}_{_{R}}_{×1} is a signal transmitted towards the target receivers, and
F(P_{N}_{_{T}}_{×N}_{_{R}}·s_{N}_{_{R}}_{×1}) is a non-linear function of a product of the precoding matrix and the signal transmitted towards the target receivers.

The transmitter device 505 may determine the undesired distortion in a null direction. For example, the transmitter device 505 may perform the following:

$$d = ( \begin{matrix}{d}_{1} \\ . \\ . \\ {d}_{{N}_{RS} + {N}_{R}}\end{matrix} ) = ( \begin{matrix}{0}_{{N}_{R} \times 1} \\ {y}_{{N}_{R} + 1} \\ . \\ . \\ {y}_{{N}_{R} + {N}_{RS}}\end{matrix} ) ,$$

where:
d is the undesired distortion (in the null direction),
d₁ is a first element of a distortion vector,
d_{N}_{_{RS}}_{+N}_{_{R}} is a last element in the distortion vector,
0_{N}_{_{R}}_{×1} is a null vector having a size of N_{R},
y_{N}_{_{R}}₊₁ is a received signal at the receiver device, and
y_{N}_{_{R}}_{+N}_{_{RS}} is a total received vector among all receiver antennas.

The transmitter device 505 may transform the distortion into a signal domain (an s domain) and may remove the distortion, for example, by multiplying the non-linear distortion by a distortion transition matrix. For example, the transmitter device 505 may perform the following:

$${s}_{n}^{delta} = {s}_{n - 1}^{delta} + {A}_{a}^{H} \cdot d and$$

$${A}_{d} = ( {0}_{{N}_{RS + {N}_{R}} \times NR - NRS} ( \begin{matrix}{0}_{{N}_{R} \times {N}_{RS}} \\ {I}_{{N}_{RS} \times {N}_{RS}}\end{matrix} ) ) = ( \begin{matrix}0 & 0 & 0 & 0 \\ 0 & ⋱ & 0 & 0 \\ 0 & 0 & 1 & 0 \\ 0 & 0 & 0 & 1\end{matrix} ) ,$$

where:
sₙ^{delta} is an updated delta signal (on a constellation) at iteration n,
sₙ₋₁^{delta} is an updated delta signal (on the constellation) at iteration n−1,
A_{d} is a transition matrix on the distortion,
A_{d}^{H} is a Hermitian transition matrix on the distortion,

$${0}_{{N}_{RS + {N}_{R}}}$$

is a zero matrix with size N_{RS} over N_{R}, and
I_{N}_{_{RS}}_{×N}_{_{RS}} is an eye matrix with a size N_{R}.

The transmitter device 505 may repeat the above for i iterations. For example, the transmitter device 505 may perform the following:

$${y}_{{N}_{R} + {N}_{RS} \times 1} = {H}_{{N}_{R} + {N}_{RS} \times {N}_{T}}^{total} \cdot F ( {P}_{{N}_{T} \times {N}_{R} + {N}_{RS}} \cdot ( A \cdot {s}_{{N}_{R} \times 1} - {A}_{d} \cdot {s}_{n}^{delta} ) ) and$$

$$A = ( \begin{matrix}I ( {N}_{R} \times {N}_{R} ) \\ 0 ( {N}_{RS} \times {N}_{R} )\end{matrix} ) ,$$

where:
A is a transition matrix on the signal.

As described above, additional energy may be added in the null direction (e.g., by adjusting the transmitted signal), which may be canceled out with post-PA distortion at the input to the target Rx antennas. Since the leakage is smaller than the signal, the amount of SNR (at the target DL) to be degraded may be small. On the other hand, the impact on the received SNR (at the victim UL) may be large, as the leakage (even if small) compared to the UL may not be negligible.

In one example, the following characteristics may be used: N_{T}=8; N_{RS}=2; N_{R}=3; FFT size equal to 1024 Hertz (Hz) with wideband precoding; assumed ideal (Raileigh) channel knowledge of the H_{3×8}^{target} and H_{2×8}^{self} (which are complex gaussian independent matrixes); thermal SNR equal to ˜30 dB (e.g., due to the noise enhancement, the received SNR may be ˜20 dB); each of the PAs are modeled using Rapp (1.1/3) and with a bandwidth occupancy (BO) of 8 dB; no digital pre-distortion (DPD); and no channel frequency response (CFR). In this example, by using (e.g., “paying”)˜0.1-0.3 dB in DL SNR, self-leakage may be improved by more than 30 dB using the linear approach, and eliminated (or mostly eliminated) using the iterative approach that cancels the PA impact. The DL SNR loss may be subject to severity of the PA.

In some aspects, the number of receiver device reception antennas plus the number of transmitter device reception antennas may be greater than the number of transmitter device transmission antennas (N_{R}+N_{RS}>N_{T}). In this case, the target (DL) SNR loss may be greater than the case where N_{R}+N_{RS}≤N_{T}. In the example that N_{T}=8, N_{RS}=4, and N_{R}=5, the SNR loss due to SI cancelation may be larger (˜few dBs) as expected.

In some aspects, the number of receiver device reception antennas plus the number of transmitter device reception antennas may be less than or equal to the number transmitter device transmission antennas (N_{R}+N_{RS}≤N_{T}). However, the number of receiver device reception antennas may be greater than the number of transmitter device reception antennas (N_{RS}>N_{R}). In this case, the number of dimensions that to be fixed (nulled) may be larger than the number of streams (that assist in the nulling). In this case, the iterative solution may have limited capabilities. In one example, N_{T}=8, N_{RS}=4, and N_{R}=3. The transition matrix may be used as described above. However, relevant dimensions in the transition matrix may be cropped, for example, as follows:

$${A}_{d} = ( {0}_{{N}_{RS + {N}_{R}} \times NR - NRS} ; ( \begin{matrix}{0}_{{N}_{R} \times {N}_{RS}} \\ {I}_{{N}_{RS} \times {N}_{RS}}\end{matrix} ) )$$

and
A_{d}^{modified}=A_{d}(:, N_{RS}−N_{R}+1:end), where:
A_{d}^{modified} is a modified (e.g., cropped) transition matrix.
   Due to this cropping, there may be a limit on how much the SI may be mitigated.

In some aspects, the transmitter device 505 may obtain information associated with the combined channel matrix

$$( {H}_{{N}_{R} + {N}_{RS} \times {N}_{T}}^{total} = ( \begin{matrix}{H}_{{N}_{R} \times {N}_{T}}^{target} \\ {H}_{{N}_{RS} \times {N}_{T}}^{self}\end{matrix} ) )$$

and the non-linear function (F (*)). The acquisition of the information associated with F (*) and H_{N}_{_{RS}}_{×N}_{_{T}}^{self} may be measured by the transmitter device 505, for example, based at least in part on performing loopback measurements. In some examples, H_{N}_{_{R}}_{×N}_{_{T}}^{target} may be estimated (e.g., assuming reciprocity) or may be signaled by the target receiver devices. In some other examples, the receiver devices (e.g., the receiver device 510) (and/or other devices) may signal a preferred precoding matrix, and the transmitter device 505 may transform the precoding matrices to channel matrices and determine the optimal precoding that satisfies the downlink connection (e.g., using channel state feedback (CSF) without SI cancelation). For example, if the target precoding matrix P_{target} is dictated by the receiver device 510 (e.g., based at least in part on the CSF) and H_{N}_{_{R}}_{+N}_{_{RS}}_{×N}_{_{T}}^{total} is not known to the transmitter device 510 (but the channel of the self-interference H_{N}_{_{RS}}_{×N}_{_{T}}^{self} is known (e.g., using self-estimation)), H_{N}_{_{R}}_{×N}_{_{T}}^{targetEst} may be estimated as follows:

$${H}_{{N}_{R} \times {N}_{T}}^{targetEst} = {P}_{target}^{H} \cdot {( {P}_{target} \cdot {P}_{target}^{H} )}^{- 1} ,$$

where:
H_{N}_{_{R}}_{×N}_{_{T}}^{targetEst} is an estimated target channel matrix,
P_{target} is a target (e.g., ideal) precoding matrix,
P_{target}^{H} is a Hermitian target precoding matrix, and
(P_{target}·P_{target}^{H})⁻¹ is a transpose of the target precoding matrix and the Hermitian target precoding matrix.
   In this case, the estimated H_{N}_{_{R}}_{×N}_{_{T}}^{targetEst} may be used to determine H_{N}_{_{R}}_{+N}_{_{RS}}_{×N}_{_{T}}^{total}.

For cases in which the transmitter device 505 is configured to use the same precoding matrix (P_{target}) that is dictated by an external source (or by its own internal considerations), there may be no “linear solution” (with such constraint), and only the non-linear (iterative) option may be used, where:

$${y}_{{N}_{R} + {N}_{RS} \times 1} = {H}_{{N}_{R} + {N}_{RS} \times {N}_{T}}^{total} \cdot F ( {P}_{{N}_{T} \times {N}_{R} + {N}_{RS}} \cdot ( A \cdot {s}_{{N}_{R} \times 1} - {A}_{d} \cdot {s}_{n}^{delta} ) ) .$$

As shown by reference number 530, the transmitter device 505 may transmit a communication to the receiver device 510 and may apply linear or non-linear interference reduction, as described herein.

As indicated above, FIG. 5 is provided as an example. Other examples may differ from what is described with regard to FIG. 5.

FIG. 6 is a diagram illustrating an example process 600 performed, for example, by a transmitter device, in accordance with the present disclosure. Example process 600 is an example where the transmitter device (e.g., transmitter device 505) performs operations associated with interference reduction.

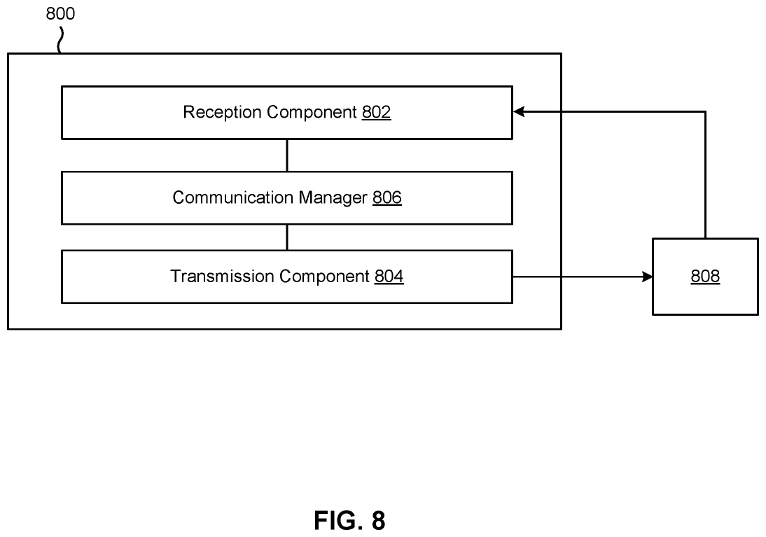

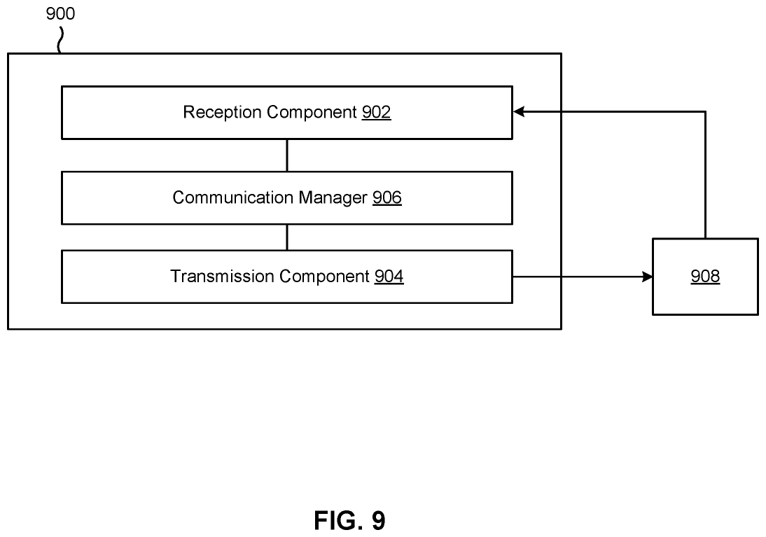

As shown in FIG. 6, in some aspects, process 600 may include obtaining a first channel matrix associated with communications between a transmitter device transmission antenna and a transmitter device reception antenna and a second channel matrix associated with communications between the transmitter device transmission antenna and a receiver device reception antenna associated with a receiver device (block 610). For example, the transmitter device (e.g., using reception component 802 and/or communication manager 806, depicted in FIG. 8, or using reception component 902 and/or communication manager 906, depicted in FIG. 9) may obtain a first channel matrix associated with communications between a transmitter device transmission antenna and a transmitter device reception antenna and a second channel matrix associated with communications between the transmitter device transmission antenna and a receiver device reception antenna associated with a receiver device, as described above.

As further shown in FIG. 6, in some aspects, process 600 may include generating a combined channel matrix based at least in part on the first channel matrix and the second channel matrix (block 620). For example, the transmitter device (e.g., using communication manager 806, depicted in FIG. 8, or using communication manager 906, depicted in FIG. 9) may generate a combined channel matrix based at least in part on the first channel matrix and the second channel matrix, as described above.

As further shown in FIG. 6, in some aspects, process 600 may include reducing interference between the transmitter device transmission antenna and the transmitter device reception antenna based at least in part on multiplying the combined channel matrix by a precoding matrix (block 630). For example, the transmitter device (e.g., using communication manager 806, depicted in FIG. 8, or using communication manager 906, depicted in FIG. 9) may reduce interference between the transmitter device transmission antenna and the transmitter device reception antenna based at least in part on multiplying the combined channel matrix by a precoding matrix, as described above.

Process 600 may include additional aspects, such as any single aspect or any combination of aspects described below and/or in connection with one or more other processes described elsewhere herein.

In a first aspect, process 600 includes transmitting to a plurality of receiver devices configured with a plurality of receiver device reception antennas, wherein the interference between the transmitter device transmission antenna and the transmitter device reception antenna is based at least in part on transmissions to the plurality of receiver devices configured with the plurality of receiver device reception antennas.

In a second aspect, alone or in combination with the first aspect, the transmitter device is configured with a quantity of transmitter device transmission antennas and a quantity of transmitter device reception antennas and the plurality of receiver devices are configured with a quantity of receiver device reception antennas corresponding to the plurality of receiver device reception antennas, wherein a sum of the quantity of receiver device reception antennas and the quantity of transmitter device reception antennas is less than or equal to the quantity of transmitter device transmission antennas, and wherein the quantity of transmitter device reception antennas is greater than or equal to the quantity of receiver device reception antennas.

In a third aspect, alone or in combination with one or more of the first and second aspects, process 600 includes identifying a total received signal based at least in part on a product of the combined channel matrix, the precoding matrix, and a null matrix.

In a fourth aspect, alone or in combination with one or more of the first through third aspects, process 600 includes identifying an eye matrix that corresponds to a product of the combined channel matrix and the precoding matrix, the eye matrix having a size that is based at least in part on a quantity of transmitter device reception antennas and a quantity of receiver device reception antennas.

In a fifth aspect, alone or in combination with one or more of the first through fourth aspects, process 600 includes generating the precoding matrix based at least in part on a product of a Hermitian combined channel matrix and an inverse of a product of the combined channel matrix and the Hermitian combined channel matrix.

In a sixth aspect, alone or in combination with one or more of the first through fifth aspects, the second channel matrix is an estimated channel matrix that is based at least in part on a conjugate transpose of the precoding matrix, the precoding matrix having a size that is based at least in part on a quantity of transmitter device reception antennas and a quantity of receiver device reception antennas.

In a seventh aspect, alone or in combination with one or more of the first through sixth aspects, the communications between the transmitter device transmission antenna and the receiver device reception antenna are full-duplex communications or sub-band full-duplex communications.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a transmitter device, in accordance with the present disclosure. Example process 700 is an example where the transmitter device (e.g., transmitter device 505) performs operations associated with interference reduction.

As shown in FIG. 7, in some aspects, process 700 may include obtaining a first channel matrix associated with communications between a transmitter device transmission antenna and a transmitter device reception antenna and a second channel matrix associated with communications between the transmitter device transmission antenna and a receiver device reception antenna associated with a receiver device (block 710). For example, the transmitter device (e.g., using reception component 802 and/or communication manager 8, depicted in FIG. 8, or using reception component 902 and/or communication manager 906, depicted in FIG. 9) may obtain a first channel matrix associated with communications between a transmitter device transmission antenna and a transmitter device reception antenna and a second channel matrix associated with communications between the transmitter device transmission antenna and a receiver device reception antenna associated with a receiver device, as described above.

As further shown in FIG. 7, in some aspects, process 700 may include generating a combined channel matrix based at least in part on the first channel matrix and the second channel matrix (block 720). For example, the transmitter device (e.g., using communication manager 806, depicted in FIG. 8, or using communication manager 906, depicted in FIG. 9) may generate a combined channel matrix based at least in part on the first channel matrix and the second channel matrix, as described above.

As further shown in FIG. 7, in some aspects, process 700 may include reducing an undesired distortion between the transmitter device transmission antenna and the transmitter device reception antenna based at least in part on a product of a distortion transition matrix and a symbol-domain transform of the undesired distortion (block 730). For example, the transmitter device (e.g., using communication manager 806, depicted in FIG. 8, or using communication manager 906, depicted in FIG. 9) may reduce an undesired distortion between the transmitter device transmission antenna and the transmitter device reception antenna based at least in part on a product of a distortion transition matrix and a symbol-domain transform of the undesired distortion, as described above.

Process 700 may include additional aspects, such as any single aspect or any combination of aspects described below and/or in connection with one or more other processes described elsewhere herein.

In a first aspect, process 700 includes transmitting to a plurality of receiver devices configured with a plurality of receiver device reception antennas, wherein the undesired distortion between the transmitter device transmission antenna and the transmitter device reception antenna is based at least in part on transmissions to the plurality of receiver devices configured with the plurality of receiver device reception antennas.

In a second aspect, alone or in combination with the first aspect, the transmitter device is configured with a quantity of transmitter device transmission antennas and a quantity of transmitter device reception antennas and the plurality of receiver devices are configured with a quantity of receiver device reception antennas corresponding to the plurality of receiver device reception antennas, each transmitter device transmission antenna being associated with a power amplifier, wherein a sum of the quantity of receiver device reception antennas and the quantity of transmitter device reception antennas is less than or equal to the quantity of transmitter device transmission antennas, and wherein the quantity of transmitter device reception antennas is greater than or equal to the quantity of receiver device reception antennas.

In a third aspect, alone or in combination with one or more of the first and second aspects, process 700 includes identifying a total received signal based at least in part on a product of the combined channel matrix and a non-linear function, wherein the non-linear function is a product of a precoding matrix and a signal to the transmitter device reception antenna.

In a fourth aspect, alone or in combination with one or more of the first through third aspects, identifying the undesired distortion comprises identifying the undesired distortion in a null direction between the transmitter device transmission antenna and the transmitter device reception antenna.

In a fifth aspect, alone or in combination with one or more of the first through fourth aspects, reducing the undesired distortion between the transmitter device transmission antenna and the transmitter device reception antenna comprises transforming the undesired distortion into a symbol-domain transform of the undesired distortion, and multiplying the symbol-domain transform of the undesired distortion by the distortion transition matrix.

In a sixth aspect, alone or in combination with one or more of the first through fifth aspects, process 700 includes identifying a total received signal based at least in part on multiplying the combined channel matrix by a product of a signal transition matrix, a transmission towards the receiver device, the distortion transition matrix, and an updated delta signal.

In a seventh aspect, alone or in combination with one or more of the first through sixth aspects, the updated delta signal is an updated delta signal at an iteration, and multiplying the combined channel matrix by the product of the signal transition matrix, the transmission towards the receiver device, the distortion transition matrix, and the updated delta signal comprises multiplying, for a plurality of iterations, the combined channel matrix by the product of the signal transition matrix, the transmission towards the receiver device, the distortion transition matrix, and a plurality of updated delta signals corresponding to the plurality of iterations.

In an eighth aspect, alone or in combination with one or more of the first through seventh aspects, an updated delta signal at a current iteration is equal to a sum of an updated delta signal at a previous iteration and a Hermitian distortion transition matrix multiplied by the undesired distortion.

In a ninth aspect, alone or in combination with one or more of the first through eighth aspects, the signal transition matrix is based at least in part on an eye matrix and a zero matrix, the eye matrix having a size that is based at least in part on a quantity of transmitter device reception antennas and the zero matrix having a size that is based at least in part on the quantity of transmitter device reception antennas and the quantity of receiver device reception antennas.

In a tenth aspect, alone or in combination with one or more of the first through ninth aspects, the communications between the transmitter device transmission antenna and the receiver device reception antenna are full-duplex communications or sub-band full-duplex communications.

In an eleventh aspect, alone or in combination with one or more of the first through tenth aspects, a quantity of transmitter device transmission antennas that includes the transmitter device transmission antenna is less than a quantity of receiver device reception antennas that includes the receiver device reception antenna and a quantity of transmitter device reception antennas that includes the transmitter device reception antenna.

In a twelfth aspect, alone or in combination with one or more of the first through eleventh aspects, a quantity of receiver device reception antennas that includes the receiver device reception antenna is greater than a quantity of transmitter device reception antennas that includes the transmitter device reception antenna.

In a thirteenth aspect, alone or in combination with one or more of the first through twelfth aspects, process 700 includes reducing or eliminating one or more dimensions of the distortion transition matrix.

In a fourteenth aspect, alone or in combination with one or more of the first through thirteenth aspects, process 700 includes performing loop-back measurements associated with the first channel matrix and a non-linear function, wherein the non-linear function is based at least in part on a precoding matrix and a signal to the transmitter device reception antenna.

In a fifteenth aspect, alone or in combination with one or more of the first through fourteenth aspects, process 700 includes estimating the second channel matrix based at least in part on a product of a Hermitian target precoding matrix and an inverse of the target precoding matrix multiplied by the Hermitian target precoding matrix.

In a sixteenth aspect, alone or in combination with one or more of the first through fifteenth aspects, the combined channel matrix is based at least in part on the first channel matrix and the estimation of the second channel matrix.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the transmitter device described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancelation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the transmitter device described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the transmitter device described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may obtain a first channel matrix associated with communications between a transmitter device transmission antenna and a transmitter device reception antenna and a second channel matrix associated with communications between the transmitter device transmission antenna and a receiver device reception antenna associated with a receiver device. The communication manager 806 may generate a combined channel matrix based at least in part on the first channel matrix and the second channel matrix. The communication manager 806 may reduce interference between the transmitter device transmission antenna and the transmitter device reception antenna based at least in part on multiplying the combined channel matrix by a precoding matrix.

The transmission component 804 may transmit to a plurality of receiver devices configured with a plurality of receiver device reception antennas, wherein the interference between the transmitter device transmission antenna and the transmitter device reception antenna is based at least in part on transmissions to the plurality of receiver devices configured with the plurality of receiver device reception antennas.

The communication manager 806 may identify a total received signal based at least in part on a product of the combined channel matrix, the precoding matrix, and a null matrix. The communication manager 806 may identify an eye matrix that corresponds to a product of the combined channel matrix and the precoding matrix, the eye matrix having a size that is based at least in part on a quantity of transmitter device reception antennas and a quantity of receiver device reception antennas. The communication manager 806 may generate the precoding matrix based at least in part on a product of a Hermitian combined channel matrix and an inverse of a product of the combined channel matrix and the Hermitian combined channel matrix.

The reception component 802 may obtain a first channel matrix associated with communications between a transmitter device transmission antenna and a transmitter device reception antenna and a second channel matrix associated with communications between the transmitter device transmission antenna and a receiver device reception antenna associated with a receiver device. The communication manager 806 may generate a combined channel matrix based at least in part on the first channel matrix and the second channel matrix. The communication manager 806 may reduce an undesired distortion between the transmitter device transmission antenna and the transmitter device reception antenna based at least in part on a product of a distortion transition matrix and a symbol-domain transform of the undesired distortion.

The transmission component 804 may transmit to a plurality of receiver devices configured with a plurality of receiver device reception antennas, wherein the undesired distortion between the transmitter device transmission antenna and the transmitter device reception antenna is based at least in part on transmissions to the plurality of receiver devices configured with the plurality of receiver device reception antennas.

The communication manager 806 may identify a total received signal based at least in part on a product of the combined channel matrix and a non-linear function, wherein the non-linear function is a product of a precoding matrix and a signal to the transmitter device reception antenna. The communication manager 806 may identify a total received signal based at least in part on multiplying the combined channel matrix by a product of a signal transition matrix, a transmission towards the receiver device, the distortion transition matrix, and an updated delta signal. The communication manager 806 may reduce or eliminate one or more dimensions of the distortion transition matrix. The communication manager 806 may perform loop-back measurements associated with the first channel matrix and a non-linear function, wherein the non-linear function is based at least in part on a precoding matrix and a signal to the transmitter device reception antenna. The communication manager 806 may estimate the second channel matrix based at least in part on a product of a Hermitian target precoding matrix and an inverse of the target precoding matrix multiplied by the Hermitian target precoding matrix.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 600 of FIG. 6, process 700 of FIG. 7, or a combination thereof. In some aspects, the apparatus 900 and/or one or more components shown in FIG. 9 may include one or more components of the transmitter device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancelation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the transmitter device described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the transmitter device described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may obtain a first channel matrix associated with communications between a transmitter device transmission antenna and a transmitter device reception antenna and a second channel matrix associated with communications between the transmitter device transmission antenna and a receiver device reception antenna associated with a receiver device. The communication manager 906 may generate a combined channel matrix based at least in part on the first channel matrix and the second channel matrix. The communication manager 906 may reduce interference between the transmitter device transmission antenna and the transmitter device reception antenna based at least in part on multiplying the combined channel matrix by a precoding matrix.

The transmission component 904 may transmit to a plurality of receiver devices configured with a plurality of receiver device reception antennas, wherein the interference between the transmitter device transmission antenna and the transmitter device reception antenna is based at least in part on transmissions to the plurality of receiver devices configured with the plurality of receiver device reception antennas.

The communication manager 906 may identify a total received signal based at least in part on a product of the combined channel matrix, the precoding matrix, and a null matrix. The communication manager 906 may identify an eye matrix that corresponds to a product of the combined channel matrix and the precoding matrix, the eye matrix having a size that is based at least in part on a quantity of transmitter device reception antennas and a quantity of receiver device reception antennas. The communication manager 906 may generate the precoding matrix based at least in part on a product of a Hermitian combined channel matrix and an inverse of a product of the combined channel matrix and the Hermitian combined channel matrix.

The reception component 902 may obtain a first channel matrix associated with communications between a transmitter device transmission antenna and a transmitter device reception antenna and a second channel matrix associated with communications between the transmitter device transmission antenna and a receiver device reception antenna associated with a receiver device. The communication manager 906 may generate a combined channel matrix based at least in part on the first channel matrix and the second channel matrix. The communication manager 906 may reduce an undesired distortion between the transmitter device transmission antenna and the transmitter device reception antenna based at least in part on a product of a distortion transition matrix and a symbol-domain transform of the undesired distortion.

The transmission component 904 may transmit to a plurality of receiver devices configured with a plurality of receiver device reception antennas, wherein the undesired distortion between the transmitter device transmission antenna and the transmitter device reception antenna is based at least in part on transmissions to the plurality of receiver devices configured with the plurality of receiver device reception antennas.

The communication manager 906 may identify a total received signal based at least in part on a product of the combined channel matrix and a non-linear function, wherein the non-linear function is a product of a precoding matrix and a signal to the transmitter device reception antenna. The communication manager 906 may identify a total received signal based at least in part on multiplying the combined channel matrix by a product of a signal transition matrix, a transmission towards the receiver device, the distortion transition matrix, and an updated delta signal. The communication manager 906 may reduce or eliminate one or more dimensions of the distortion transition matrix. The communication manager 906 may perform loop-back measurements associated with the first channel matrix and a non-linear function, wherein the non-linear function is based at least in part on a precoding matrix and a signal to the transmitter device reception antenna. The communication manager 906 may estimate the second channel matrix based at least in part on a product of a Hermitian target precoding matrix and an inverse of the target precoding matrix multiplied by the Hermitian target precoding matrix.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a transmitter device, comprising: obtaining a first channel matrix associated with communications between a transmitter device transmission antenna and a transmitter device reception antenna and a second channel matrix associated with communications between the transmitter device transmission antenna and a receiver device reception antenna associated with a receiver device; generating a combined channel matrix based at least in part on the first channel matrix and the second channel matrix; and reducing interference between the transmitter device transmission antenna and the transmitter device reception antenna based at least in part on multiplying the combined channel matrix by a precoding matrix.

Aspect 2: The method of Aspect 1, further comprising transmitting to a plurality of receiver devices configured with a plurality of receiver device reception antennas, wherein the interference between the transmitter device transmission antenna and the transmitter device reception antenna is based at least in part on transmissions to the plurality of receiver devices configured with the plurality of receiver device reception antennas.

Aspect 3: The method of Aspect 2, wherein the transmitter device is configured with a quantity of transmitter device transmission antennas and a quantity of transmitter device reception antennas and the plurality of receiver devices are configured with a quantity of receiver device reception antennas corresponding to the plurality of receiver device reception antennas, wherein a sum of the quantity of receiver device reception antennas and the quantity of transmitter device reception antennas is less than or equal to the quantity of transmitter device transmission antennas, and wherein the quantity of transmitter device reception antennas is greater than or equal to the quantity of receiver device reception antennas.

Aspect 4: The method of any of Aspects 1-3, further comprising identifying a total received signal based at least in part on a product of the combined channel matrix, the precoding matrix, and a null matrix.

Aspect 5: The method of Aspect 4, further comprising identifying an eye matrix that corresponds to a product of the combined channel matrix and the precoding matrix, the eye matrix having a size that is based at least in part on a quantity of transmitter device reception antennas and a quantity of receiver device reception antennas.

Aspect 6: The method of Aspect 4, further comprising generating the precoding matrix based at least in part on a product of a Hermitian combined channel matrix and an inverse of a product of the combined channel matrix and the Hermitian combined channel matrix.

Aspect 7: The method of any of Aspects 1-6, wherein the second channel matrix is an estimated channel matrix that is based at least in part on a conjugate transpose of the precoding matrix, the precoding matrix having a size that is based at least in part on a quantity of transmitter device reception antennas and a quantity of receiver device reception antennas.

Aspect 8: The method of any of Aspects 1-7, wherein the communications between the transmitter device transmission antenna and the receiver device reception antenna are full-duplex communications or sub-band full-duplex communications.

Aspect 9: A method of wireless communication performed by a transmitter device, comprising: obtaining a first channel matrix associated with communications between a transmitter device transmission antenna and a transmitter device reception antenna and a second channel matrix associated with communications between the transmitter device transmission antenna and a receiver device reception antenna associated with a receiver device; generating a combined channel matrix based at least in part on the first channel matrix and the second channel matrix; and reducing an undesired distortion between the transmitter device transmission antenna and the transmitter device reception antenna based at least in part on a product of a distortion transition matrix and a symbol-domain transform of the undesired distortion.

Aspect 10: The method of Aspect 9, further comprising transmitting to a plurality of receiver devices configured with a plurality of receiver device reception antennas, wherein the undesired distortion between the transmitter device transmission antenna and the transmitter device reception antenna is based at least in part on transmissions to the plurality of receiver devices configured with the plurality of receiver device reception antennas.

Aspect 11: The method of Aspect 10, wherein the transmitter device is configured with a quantity of transmitter device transmission antennas and a quantity of transmitter device reception antennas and the plurality of receiver devices are configured with a quantity of receiver device reception antennas corresponding to the plurality of receiver device reception antennas, each transmitter device transmission antenna being associated with a power amplifier, wherein a sum of the quantity of receiver device reception antennas and the quantity of transmitter device reception antennas is less than or equal to the quantity of transmitter device transmission antennas, and wherein the quantity of transmitter device reception antennas is greater than or equal to the quantity of receiver device reception antennas.

Aspect 12: The method of any of Aspects 9-11, further comprising identifying a total received signal based at least in part on a product of the combined channel matrix and a non-linear function, wherein the non-linear function is a product of a precoding matrix and a signal to the transmitter device reception antenna.

Aspect 13: The method of any of Aspects 9-12, wherein identifying the undesired distortion comprises identifying the undesired distortion in a null direction between the transmitter device transmission antenna and the transmitter device reception antenna.

Aspect 14: The method of Aspect 13, wherein reducing the undesired distortion between the transmitter device transmission antenna and the transmitter device reception antenna comprises: transforming the undesired distortion into a symbol-domain transform of the undesired distortion; and multiplying the symbol-domain transform of the undesired distortion by the distortion transition matrix.

Aspect 15: The method of Aspect 14, further comprising identifying a total received signal based at least in part on multiplying the combined channel matrix by a product of a signal transition matrix, a transmission towards the receiver device, the distortion transition matrix, and an updated delta signal.

Aspect 16: The method of Aspect 15, wherein the updated delta signal is an updated delta signal at an iteration, and wherein multiplying the combined channel matrix by the product of the signal transition matrix, the transmission towards the receiver device, the distortion transition matrix, and the updated delta signal comprises multiplying, for a plurality of iterations, the combined channel matrix by the product of the signal transition matrix, the transmission towards the receiver device, the distortion transition matrix, and a plurality of updated delta signals corresponding to the plurality of iterations.

Aspect 17: The method of Aspect 16, wherein an updated delta signal at a current iteration is equal to a sum of an updated delta signal at a previous iteration and a Hermitian distortion transition matrix multiplied by the undesired distortion.

Aspect 18: The method of Aspect 15, wherein the signal transition matrix is based at least in part on an eye matrix and a zero matrix, the eye matrix having a size that is based at least in part on a quantity of transmitter device reception antennas and the zero matrix having a size that is based at least in part on the quantity of transmitter device reception antennas and the quantity of receiver device reception antennas.

Aspect 19: The method of any of Aspects 9-18, wherein the communications between the transmitter device transmission antenna and the receiver device reception antenna are full-duplex communications or sub-band full-duplex communications.

Aspect 20: The method of any of Aspects 9-19, wherein a quantity of transmitter device transmission antennas that includes the transmitter device transmission antenna is less than a quantity of receiver device reception antennas that includes the receiver device reception antenna and a quantity of transmitter device reception antennas that includes the transmitter device reception antenna.

Aspect 21: The method of any of Aspects 9-20, wherein a quantity of receiver device reception antennas that includes the receiver device reception antenna is greater than a quantity of transmitter device reception antennas that includes the transmitter device reception antenna.

Aspect 22: The method of Aspect 21, further comprising reducing or eliminating one or more dimensions of the distortion transition matrix.

Aspect 23: The method of any of Aspects 9-22, further comprising performing loop-back measurements associated with the first channel matrix and a non-linear function, wherein the non-linear function is based at least in part on a precoding matrix and a signal to the transmitter device reception antenna.

Aspect 24: The method of any of Aspects 9-23, further comprising estimating the second channel matrix based at least in part on a product of a Hermitian target precoding matrix and an inverse of the target precoding matrix multiplied by the Hermitian target precoding matrix.

Aspect 25: The method of Aspect 24, wherein the combined channel matrix is based at least in part on the first channel matrix and the estimation of the second channel matrix.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitter device for wireless communication, comprising:
one or more memories; and
one or more processors, coupled to the one or more memories, configured to:
obtain a first channel matrix associated with communications between a transmitter device transmission antenna and a transmitter device reception antenna and a second channel matrix associated with communications between the transmitter device transmission antenna and a receiver device reception antenna associated with a receiver device;
generate a combined channel matrix based at least in part on the first channel matrix and the second channel matrix; and
reduce interference between the transmitter device transmission antenna and the transmitter device reception antenna based at least in part on multiplying the combined channel matrix by a precoding matrix.

2. The transmitter device of claim 1, wherein the one or more processors are further configured to transmit to a plurality of receiver devices configured with a plurality of receiver device reception antennas, wherein the interference between the transmitter device transmission antenna and the transmitter device reception antenna is based at least in part on transmissions to the plurality of receiver devices configured with the plurality of receiver device reception antennas.

3. The transmitter device of claim 2, wherein the transmitter device is configured with a quantity of transmitter device transmission antennas and a quantity of transmitter device reception antennas and the plurality of receiver devices are configured with a quantity of receiver device reception antennas corresponding to the plurality of receiver device reception antennas, wherein a sum of the quantity of receiver device reception antennas and the quantity of transmitter device reception antennas is less than or equal to the quantity of transmitter device transmission antennas, and wherein the quantity of transmitter device reception antennas is greater than or equal to the quantity of receiver device reception antennas.

4. The transmitter device of claim 1, wherein the one or more processors are further configured to identify a total received signal based at least in part on a product of the combined channel matrix, the precoding matrix, and a null matrix.

5. The transmitter device of claim 4, wherein the one or more processors are further configured to identify an eye matrix that corresponds to a product of the combined channel matrix and the precoding matrix, the eye matrix having a size that is based at least in part on a quantity of transmitter device reception antennas and a quantity of receiver device reception antennas.

6. The transmitter device of claim 4, wherein the one or more processors are further configured to generate the precoding matrix based at least in part on a product of a Hermitian combined channel matrix and an inverse of a product of the combined channel matrix and the Hermitian combined channel matrix.

7. The transmitter device of claim 1, wherein the second channel matrix is an estimated channel matrix that is based at least in part on a conjugate transpose of the precoding matrix, the precoding matrix having a size that is based at least in part on a quantity of transmitter device reception antennas and a quantity of receiver device reception antennas.

8. The transmitter device of claim 1, wherein the communications between the transmitter device transmission antenna and the receiver device reception antenna are full-duplex communications or sub-band full-duplex communications.

9. A transmitter device for wireless communication, comprising:
one or more memories; and
one or more processors, coupled to the one or more memories, configured to:
obtain a first channel matrix associated with communications between a transmitter device transmission antenna and a transmitter device reception antenna and a second channel matrix associated with communications between the transmitter device transmission antenna and a receiver device reception antenna associated with a receiver device;
generate a combined channel matrix based at least in part on the first channel matrix and the second channel matrix; and
reduce an undesired distortion between the transmitter device transmission antenna and the transmitter device reception antenna based at least in part on a product of a distortion transition matrix and a symbol-domain transform of the undesired distortion.

10. The transmitter device of claim 9, wherein the one or more processors are further configured to transmit to a plurality of receiver devices configured with a plurality of receiver device reception antennas, wherein the undesired distortion between the transmitter device transmission antenna and the transmitter device reception antenna is based at least in part on transmissions to the plurality of receiver devices configured with the plurality of receiver device reception antennas.

11. The transmitter device of claim 10, wherein the transmitter device is configured with a quantity of transmitter device transmission antennas and a quantity of transmitter device reception antennas and the plurality of receiver devices are configured with a quantity of receiver device reception antennas corresponding to the plurality of receiver device reception antennas, each transmitter device transmission antenna being associated with a power amplifier, wherein a sum of the quantity of receiver device reception antennas and the quantity of transmitter device reception antennas is less than or equal to the quantity of transmitter device transmission antennas, and wherein the quantity of transmitter device reception antennas is greater than or equal to the quantity of receiver device reception antennas.

12. The transmitter device of claim 9, wherein the one or more processors are further configured to identify a total received signal based at least in part on a product of the combined channel matrix and a non-linear function, wherein the non-linear function is a product of a precoding matrix and a signal to the transmitter device reception antenna.

13. The transmitter device of claim 9, wherein the one or more processors, to identify the undesired distortion, are configured to identify the undesired distortion in a null direction between the transmitter device transmission antenna and the transmitter device reception antenna.

14. The transmitter device of claim 13, wherein the one or more processors, to reduce the undesired distortion between the transmitter device transmission antenna and the transmitter device reception antenna, are configured to:
transform the undesired distortion into a symbol-domain transform of the undesired distortion; and
multiply the symbol-domain transform of the undesired distortion by the distortion transition matrix.

15. The transmitter device of claim 14, wherein the one or more processors are further configured to identify a total received signal based at least in part on multiplying the combined channel matrix by a product of a signal transition matrix, a transmission towards the receiver device, the distortion transition matrix, and an updated delta signal.

16. The transmitter device of claim 15, wherein the updated delta signal is an updated delta signal at an iteration, and wherein multiplying the combined channel matrix by the product of the signal transition matrix, the transmission towards the receiver device, the distortion transition matrix, and the updated delta signal comprises multiplying, for a plurality of iterations, the combined channel matrix by the product of the signal transition matrix, the transmission towards the receiver device, the distortion transition matrix, and a plurality of updated delta signals corresponding to the plurality of iterations.

17. The transmitter device of claim 16, wherein an updated delta signal at a current iteration is equal to a sum of an updated delta signal at a previous iteration and a Hermitian distortion transition matrix multiplied by the undesired distortion.

18. The transmitter device of claim 15, wherein the signal transition matrix is based at least in part on an eye matrix and a zero matrix, the eye matrix having a size that is based at least in part on a quantity of transmitter device reception antennas and the zero matrix having a size that is based at least in part on the quantity of transmitter device reception antennas and the quantity of receiver device reception antennas.

19. The transmitter device of claim 9, wherein the communications between the transmitter device transmission antenna and the receiver device reception antenna are full-duplex communications or sub-band full-duplex communications.

20. The transmitter device of claim 9, wherein a quantity of transmitter device transmission antennas that includes the transmitter device transmission antenna is less than a quantity of receiver device reception antennas that includes the receiver device reception antenna and a quantity of transmitter device reception antennas that includes the transmitter device reception antenna.

21. The transmitter device of claim 9, wherein a quantity of receiver device reception antennas that includes the receiver device reception antenna is greater than a quantity of transmitter device reception antennas that includes the transmitter device reception antenna.

22. The transmitter device of claim 21, wherein the one or more processors are further configured to reduce or eliminate one or more dimensions of the distortion transition matrix.

23. The transmitter device of claim 9, wherein the one or more processors are further configured to perform loop-back measurements associated with the first channel matrix and a non-linear function, wherein the non-linear function is based at least in part on a precoding matrix and a signal to the transmitter device reception antenna.

24. The transmitter device of claim 9, wherein the one or more processors are further configured to estimate the second channel matrix based at least in part on a product of a Hermitian target precoding matrix and an inverse of a target precoding matrix multiplied by the Hermitian target precoding matrix.

25. The transmitter device of claim 24, wherein the combined channel matrix is based at least in part on the first channel matrix and the estimation of the second channel matrix.

26. A method of wireless communication performed by a transmitter device, comprising:
obtaining a first channel matrix associated with communications between a transmitter device transmission antenna and a transmitter device reception antenna and a second channel matrix associated with communications between the transmitter device transmission antenna and a receiver device reception antenna associated with a receiver device;
generating a combined channel matrix based at least in part on the first channel matrix and the second channel matrix; and
reducing interference between the transmitter device transmission antenna and the transmitter device reception antenna based at least in part on multiplying the combined channel matrix by a precoding matrix.

27. The method of claim 26, further comprising identifying a total received signal based at least in part on a product of the combined channel matrix, the precoding matrix, and a null matrix.

28. The method of claim 27, further comprising generating the precoding matrix based at least in part on a product of a Hermitian combined channel matrix and an inverse of a product of the combined channel matrix and the Hermitian combined channel matrix.

29. A method of wireless communication performed by a transmitter device, comprising:
obtaining a first channel matrix associated with communications between a transmitter device transmission antenna and a transmitter device reception antenna and a second channel matrix associated with communications between the transmitter device transmission antenna and a receiver device reception antenna associated with a receiver device;
generating a combined channel matrix based at least in part on the first channel matrix and the second channel matrix; and
reducing an undesired distortion between the transmitter device transmission antenna and the transmitter device reception antenna based at least in part on a product of a distortion transition matrix and a symbol-domain transform of the undesired distortion.

30. The method of claim 29, further comprising identifying a total received signal based at least in part on a product of the combined channel matrix and a non-linear function, wherein the non-linear function is a product of a precoding matrix and a signal to the transmitter device reception antenna.
